(19) United States
(12) Patent Application Publication
(10) Pub. No.: US 2024/0338412 A1
(43) Pub. Date: Oct. 10, 2024

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Yumiko SHINOHARA, Kyoto (JP); Kihiro YUASA, Kanagawa (JP)

(73) Assignee: Panasonic Intellectual Property Corporation of America, Torrance, CA (US)

(21) Appl. No.: 18/748,735

(22) Filed: Jun. 20, 2024

Related U.S. Application Data
(63) Continuation of application No. PCT/JP2022/032063, filed on Aug. 25, 2022.

(30) Foreign Application Priority Data
Dec. 21, 2021 (JP) 2021-207343

(51) Int. Cl. G06F 16/9035; G06F 16/908

(52) U.S. Cl. CPC G06F 16/9035; G06F 16/908

(57) ABSTRACT

An information processing apparatus acquires a cooking menu indicative of a cooking way of a foodstuff; extracts foodstuff information indicative of the foodstuff to be used for the cooking menu and foodstuff cooking information indicative of the cooking way of the foodstuff on the basis of the cooking menu; and determines an accomplishment difficulty of the cooking menu on the basis of the foodstuff information and the foodstuff cooking information.

### FIELD OF INVENTION

The present disclosure relates to a technique of assisting cooking.

### BACKGROUND ART

Patent Literature 1 discloses a technique of reducing a gap between a difficulty of a recipe given by its creator and a difficulty of the recipe for a user to accurately estimate a difficulty of the recipe for each user. Specifically, Patent Literature 1 discloses a technique of: determining a difficulty associated with an attribute of a user and a dish type of a dish that the user desires to make by reference to correspondence information having a predetermined difficulty associated with a dish type and an attribute including a nationality and years of cooking experience; and designating the determined difficulty as a difficulty of a recipe for the user.

However, the technique of Patent Literature 1 involves no consideration of a cooking step that constitutes a cooking menu. Thus, further improvement is required to accurately estimate a difficulty of a recipe.
Patent Literature 1: Japanese Unexamined Patent Publication No. 2021-56997

### SUMMARY OF THE INVENTION

The present disclosure has been made to solve the above-mentioned problems, and provides a technique that enables accurate determination of a difficulty of a cooking menu.

An information processing method according to an aspect of the present disclosure, by a computer, includes: (A) acquiring a cooking menu indicative of a cooking way of a foodstuff; (B) extracting foodstuff information indicative of the foodstuff to be used for the cooking menu and foodstuff cooking information indicative of the cooking way of the foodstuff on the basis of the cooking menu; and (C) determining an accomplishment difficulty of the cooking menu on the basis of the foodstuff information and the foodstuff cooking information.

The present disclosure enables accurate determination of a difficulty of a cooking menu.

### BRIEF DESCRIPTION OF THE DRAWINGS

FIG. 1 is a block diagram showing an exemplary information processing system according to a first embodiment of the present disclosure.

FIG. 2 is a step information table in an exemplary data configuration.

FIG. 3 is a difficulty table in an exemplary data configuration.

FIG. 4 is a difficulty table in an exemplary data configuration.

FIG. 5 is a cooking skill table in an exemplary data configuration.

FIG. 6 is a flowchart showing an exemplary process of an information processing apparatus according to the first embodiment.

FIG. 7 is an illustration showing an exemplary display image.

FIG. 8 is a difficulty table in an exemplary data configuration in a modification (2) of the first embodiment.

FIG. 9 is an illustration showing an exemplary display image in a modification (4) of the first embodiment of the present disclosure.

FIG. 10 is a user attribute table in an exemplary data configuration.

FIG. 11 is an attribute information table in an exemplary data configuration.

FIG. 12 is a flowchart showing an exemplary process of an information processing apparatus according to a second embodiment.

FIG. 13 is a block diagram showing an exemplary structure of an information processing apparatus according to a third embodiment of the present disclosure.

FIG. 14 is a flowchart of an exemplary process in the third embodiment of the present disclosure.

FIG. 15 is a flowchart showing an exemplary process of the information processing apparatus in a modification of the third embodiment.

FIG. 16 is an illustration showing an exemplary display image in a modification (2) of the present disclosure.

### DETAILED DESCRIPTION

Circumstances that Led to One Aspect of Present Disclosure

Some children get interested in cooking through a cooking experience in a cooking class. In this regard, a technique of facilitating help by a child with cooking has been considered. The technique requires appropriate determination of a difficulty of a dish to involve help by a child and a cooking level of the child. Since the difficulty of a dish varies according to a foodstuff to be used in the dish and a cooking way of the foodstuff, it is necessary for an accurate determination of the difficulty of the dish to consider these factors.

Patent Literature 1 merely provides a technique of determining a difficulty associated with an attribute of a user and a dish type of a dish that the user desires to make, and involves no consideration of a foodstuff to be used in making the dish and a cooking way of the foodstuff. Thus, further improvement is required to accurately determine a difficulty of a dish.

The present disclosure has been made to solve the above-mentioned problems.

(1) An information processing method according to an aspect of the present disclosure, by a computer, includes: (A) acquiring a cooking menu indicative of a cooking way of a foodstuff; (B) extracting foodstuff information indicative of the foodstuff to be used for the cooking menu and foodstuff cooking information indicative of the cooking way of the foodstuff on the basis of the cooking menu; and (C) determining an accomplishment difficulty of the cooking menu on the basis of the foodstuff information and the foodstuff cooking information.

In this configuration, foodstuff information indicative of a foodstuff to be used for a cooking menu and foodstuff cooking information indicative of a cooking way of the foodstuff are extracted from the cooking menu, and an accomplishment difficulty of the cooking menu is determined on the basis of the foodstuff information and the foodstuff cooking information. Thus, an accomplishment difficulty of the cooking menu is accurately determined.

(2) In the information processing method described in (1) above, the cooking menu may include a plurality of cooking steps, and in (C), an accomplishment difficulty of each of the cooking steps may be determined.

In this configuration, an accomplishment difficulty of each of the cooking steps included in the cooking menu is determined. This enables provision of judging criteria for determining a cooking step that may involve help by a child among the cooking steps.

(3) In the information processing method described in (1) or (2) above, in (C), a first value associated with a feature of the foodstuff may be acquired on the basis of the foodstuff information, a second value associated with a feature of the cooking way of the foodstuff may be acquired on the basis of the foodstuff cooking information, and the accomplishment difficulty of the cooking menu may be determined by combining the first value and the second value with each other.

This configuration enables accurate determination of the accomplishment difficulty of the cooking menu in consideration of a feature of a foodstuff to be used in the cooking menu and a feature of a cooking way of the foodstuff.

(4) In the information processing method described in any one of (1) to (3) above, in (B), utensil information indicative of a utensil to be used for cooking the foodstuff may be further extracted from the cooking menu, and estimation information indicative of a cooking way that is estimated on the basis of the utensil information for the foodstuff may be acquired as the foodstuff cooking information.

In this configuration, foodstuff cooking information is acquired by estimating a cooking way of a foodstuff from utensil information indicative of a utensil to be used for the cooking menu. Thus, the foodstuff cooking information can be accurately determined.

(5) In the information processing method described in (2) above, in (B), utensil information indicative of a utensil to be used for cooking the foodstuff may be further extracted from the cooking menu, and in (C), an accomplishment difficulty of each of the cooking steps may be determined on the basis of the foodstuff information, the foodstuff cooking information, and the utensil information.

This configuration enables accurate determination of the accomplishment difficulty of each of the cooking steps based on the foodstuff information, the foodstuff cooking information, and the utensil information extracted from the cooking menu.

(6) The information processing method described in (2) above may further include: (D) acquiring cooking skill information for a target user; and (E) determining whether each of the cooking steps is accomplishable by the target user on the basis of the cooking skill information and the accomplishment difficulty of each of the cooking steps.

In this configuration, it is determined whether each of the cooking steps is accomplishable by a target user. This enables provision of judging criteria for a cooking step with which the target user can provide help among a plurality of cooking steps. Consequently, help by the target user can be facilitated. Further, a cooking step accomplishable by the target user is determined on the basis of cooking skill information for the target user and the accomplishment difficulty of each of the cooking steps. Thus, a cooking step accomplishable by a target user can be determined in consideration of a cooking skill of the target user.

(7) The information processing method described in (2) above may further include: (D) acquiring, from an attribute database including an accomplishment rate of each of the cooking steps by an unspecified user associated with each attribute of the unspecified user, an accomplishment rate associated with an attribute of a target user as the accomplishment difficulty; and (E) determining, in a case where there is a cooking step having an acquired accomplishment difficulty not less than a threshold, that the target user is capable of accomplishing the cooking step.

In this configuration, it is determined whether each of the cooking steps is accomplishable by a target user. This enables provision of judging criteria for a cooking step with which the target user can provide help among a plurality of cooking steps. Consequently, help by the target user can be facilitated. Further, among accomplishment rates each of which is predetermined on the basis of an accomplishment result of each of the cooking steps by an unspecified user and is associated with an attribute, an accomplishment rate associated with an attribute of the target user is recognized as an accomplishment rate for the target user, and the accomplishment rate is compared with a threshold to determine a cooking step accomplishable by the target user. Therefore, a cooking step accomplishable by a target user can be easily determined without keeping of each accomplishment rate for the target user.

(8) The information processing method described in (5) or (7) above may further include: (F) generating, in a case where there is an accomplishable cooking step that is determined to be a cooking step accomplishable by the target user, a display image having accomplishable cooking information indicative of the accomplishable cooking step superimposed on a display field for the accomplishable cooking step in display fields for the cooking steps; and (G) outputting the display image.

In this configuration, a display image having accomplishable cooking information superimposed on a display field for an accomplishable cooking step in display fields for the cooking steps is generated, and the display image is output. This enables a target user to easily recognize which of the cooking steps is a cooking step with which the target user can provide help.

(9) In the information processing method described in (8) above, the target user may include a first target user and a second target user, the accomplishable cooking information may include first accomplishable cooking information indicative of an accomplishable cooking step by the first target user and second accomplishable cooking information indicative of an accomplishable cooking step by the second target user, and the display image may include an image having, in the display fields for the cooking steps, the first accomplishable cooking information superimposed on a display field for the accomplishable cooking step by the first target user and the second accomplishable cooking information superimposed on a display field for the accomplishable cooking step by the second target user.

This configuration enables generation of a display image distinguishably showing respective cooking steps accomplishable by a first target user and a second target user, and thus can facilitate help by a plurality of target users.

(10) In the information processing method described in (8) above, the target user may include a first target user and a second target user, the accomplishable cooking information may include first accomplishable cooking information indicative of an accomplishable cooking step by the first target user and second accomplishable cooking information indicative of an accomplishable cooking step by the second target user, and the display image may include a first display image having the first accomplishable cooking information superimposed on a display field for the accomplishable cooking step by the first target user in the display field for the cooking steps and a second display image having the second accomplishable cooking information superimposed on a display field for the accomplishable cooking step by the second target user in the display field for the cooking steps.

In this configuration, a first display image showing a cooking step accomplishable by the first target user and a second display image showing a cooking step accomplishable by the second target user can be generated separately, and thus the first display image and the second display image can be displayed separately. This can draw a clear distinction between respective cooking steps accomplishable by the first target user and the second target user.

(11) The information processing method described in (6) above may further include: (H) acquiring a cooking result of a cooking operation that is included in the cooking menu and completed by the target user; and (I) modifying the cooking skill information for the target user on the basis of the cooking result, and in (D), the modified cooking skill information may be acquired as the cooking skill information for the target user.

In this configuration, cooking skill information of a target user is modified in consideration of a cooking result. Thus, accuracy in determination of a cooking step accomplishable by a target user can be improved.

(12) The information processing method described in (7) above may further include: (H) acquiring a cooking result of a cooking operation that is included in the cooking menu and completed by the target user; and (I) modifying the accomplishment rate stored in the attribute database on the basis of the cooking result, and in (D), the modified accomplishment rate may be acquired as the accomplishment difficulty.

In this configuration, an accomplishment rate stored in the attribute database is modified in consideration of a cooking result. Thus, the accuracy in the determination of a cooking step accomplishable by a target user can be improved.

(13) An information processing apparatus according to another aspect of the present disclosure includes: an acquisition part for acquiring a cooking menu indicative of a cooking way of a foodstuff; an extraction part for extracting foodstuff information indicative of the foodstuff to be used for the cooking menu and foodstuff cooking information indicative of the cooking way of the foodstuff on the basis of the cooking menu; and a determination part for determining an accomplishment difficulty of the cooking menu on the basis of the foodstuff information and the foodstuff cooking information.

This configuration enables provision of an information processing apparatus that implements the information processing method.

(14) In the information processing apparatus described in (13) above, the cooking menu may include a plurality of cooking steps, and the determination part may determine an accomplishment difficulty of each of the cooking steps.

This configuration exerts the same advantageous effects as those described for the information processing method described in (2) above.

(15) In the information processing apparatus described in (13) or (14) above, the determination part may acquire a first value associated with a feature of the foodstuff on the basis of the foodstuff information, acquire a second value associated with a feature of the cooking way of the foodstuff on the basis of the foodstuff cooking information, and determine the accomplishment difficulty of the cooking menu by combining the first value and the second value with each other.

This configuration exerts the same advantageous effects as those described for the information processing method described in (3) above.

(16) In the information processing apparatus described in (14) above, the acquisition part may acquire cooking skill information for a target user; and the determination part may determine whether each of the cooking steps is accomplishable by the target user on the basis of the cooking skill information and the accomplishment difficulty of each of the cooking steps.

This configuration exerts the same advantageous effects as those described for the information processing method described in (6) above.

(17) The information processing apparatus described in (16) above may further include: a generation part for generating, in a case where there is an accomplishable cooking step that is determined to be a cooking step accomplishable by the target user, a display image having accomplishable cooking information indicative of the accomplishable cooking step superimposed on a field indicative of the accomplishable cooking step; and an output part for outputting the display image.

This configuration exerts the same advantageous effects as those described for the information processing method described in (8) above.

(18) A program according to another aspect of the present disclosure causes a computer to execute a process of: (A) acquiring a cooking menu indicative of a cooking way of a foodstuff; (B) extracting foodstuff information indicative of the foodstuff to be used for the cooking menu and foodstuff cooking information indicative of the cooking way of the foodstuff on the basis of the cooking menu; and (C) determining an accomplishment difficulty of the cooking menu on the basis of the foodstuff information and the foodstuff cooking information.

This configuration enables provision of an information processing program that implements the information processing method.

The disclosure can be realized as an information processing system operated by the information processing program. Additionally, it goes without saying that the program is distributable as a non-transitory computer readable storage medium like a CD-ROM, or distributable via a communication network like the Internet.

Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### First Embodiment

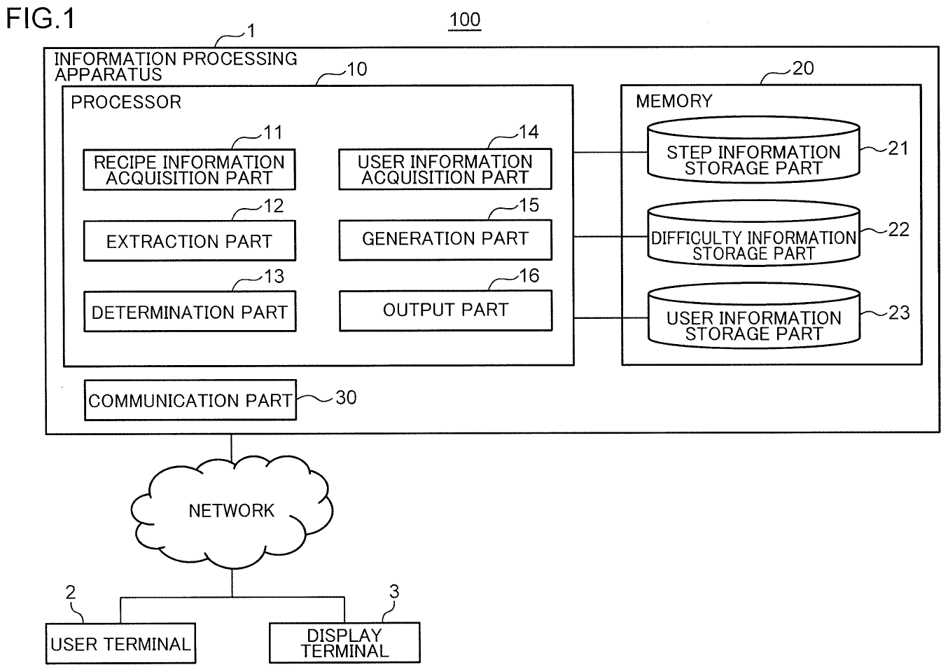

FIG. 1 is a block diagram showing an exemplary information processing system 100 according to a first embodiment of the present disclosure. The information processing system 100 provides, in a case where a supervisor such as a guardian or a parent allows a user such as a child to provide help with cooking, an assistance service for assisting the supervisor and the user.

The information processing system 100 includes an information processing apparatus 1, a user terminal 2, and a display terminal 3. The information processing apparatus 1, the user terminal 2, and the display terminal 3 are communicably connected with each other via a network. The network is, e.g., a wide area network including the Internet.

The information processing apparatus 1 is, e.g., a server device including one or more computers. The user terminal 2 is a mobile computer, e.g., a smartphone or a tablet computer, and is owned by a guardian of a user. The user is, e.g., a child of the guardian. The user is an exemplary target user. The user terminal 2 accepts various information input by the guardian. The information to be input is, e.g., recipe information. The display terminal 3 is, e.g., a mobile computer such as a smartphone and a tablet, and displays a display image showing the recipe information. The display terminal 3 may be an electric device having a display, or may be an integral display device that is attached to a wall of a house and allows collective control of electric devices in the house. The electric device is, e.g., a convection microwave oven or a refrigerator. The user terminal 2 and the display terminal 3 may be included in the same terminal.

The information processing apparatus 1 includes a processor 10, a memory 20, and a communication part 30. The processor 10 includes, e.g., a CPU. The processor 10 includes a recipe information acquisition part 11, an extraction part 12, a determination part 13, a user information acquisition part 14, a generation part 15, and an output part 16. The recipe information acquisition part 11, the extraction part 12, the determination part 13, the user information acquisition part 14, the generation part 15, and the output part 16 may do performance when the processor 10 executes an information processing program, or may be constituted by dedicated hardware, e.g., an ASIC.

The recipe information acquisition part 11 acquires recipe information transmitted from the user terminal 2 through the communication part 30. The recipe information is an exemplary cooking menu indicative of a cooking way of a foodstuff. The recipe information is information on a recipe indicative of how to make a dish. The recipe information includes, e.g., information indicative of a plurality of cooking steps for making a dish and information indicative of a foodstuff to be used in each of the cooking steps.

The extraction part 12 extracts foodstuff information indicative of a foodstuff to be used for a recipe indicated by the recipe information and foodstuff cooking information indicative of a cooking way of the foodstuff on the basis of the recipe information. The foodstuff information includes a name of a foodstuff, e.g., “Carrot” or “Tomato”. The foodstuff cooking information includes information indicative of a cooking action, e.g., “Cut”, “Random Shaped Cut”, “Fry”, or “Blend”.

The determination part 13 determines an accomplishment difficulty of the recipe indicated by the recipe information on the basis of the foodstuff information and the foodstuff cooking information extracted by the extraction part 12. The accomplishment difficulty is represented by a value and indicates how hard it is to make a dish indicated by the recipe. In the embodiment, the determination part 13 determines respective accomplishment difficulties of the cooking steps. The determination part 13 determines a cooking step that is accomplishable by the user among the cooking steps on the basis of the accomplishment difficulty of each of the cooking steps and cooking skill information for the user.

The user information acquisition part 14 acquires user information from a user information storage part 23. The user information includes the cooking skill information for the user. The cooking skill information is information indicative of a level of the user for cooking.

The generation part 15 generates, in a case where there is an accomplishable cooking step that is determined to be a cooking step accomplishable by the user, a display image having accomplishable cooking information indicative of the accomplishable cooking step superimposed on a display field for the accomplishable cooking step in display fields for the cooking steps included in the recipe information.

The output part 16 transmits the display image generated by the generation part 15 to the display terminal 3 through the communication part 30. Thus, the display terminal 3 can display the display image.

The memory 20 includes a storage device that is non-volatile and rewritable, e.g., a hard disk drive or a solid state drive. The memory 20 includes a step information storage part 21, a difficulty information storage part 22, and the user information storage part 23.

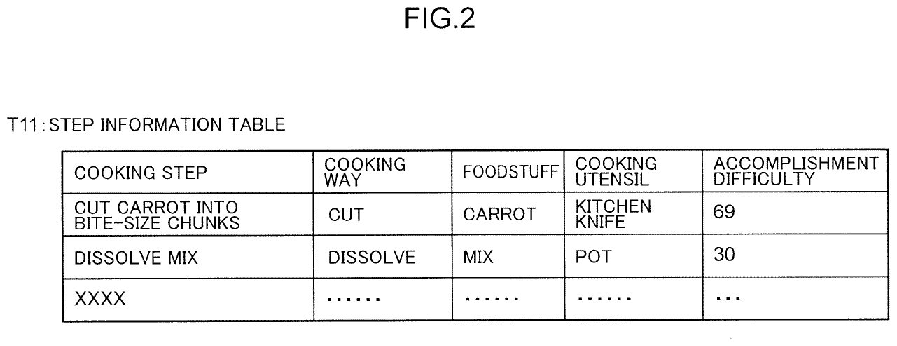

The step information storage part 21 stores a step information table T11. FIG. 2 is a step information table T11 in an exemplary data configuration. The step information table T11 is a table for determination of the accomplishment difficulty of each of the cooking steps, and has step information specifying a content of a cooking step. One record in the step information table T11 corresponds to one step information piece.

The step information table T11 has “Cooking Step”, “Cooking Way”, “Foodstuff”, “Utensil”, and “Accomplishment Difficulty”. “Cooking Step” is a label specifying a cooking step. “Cooking Step” represents a combination of a foodstuff to be cooked and a cooking way of the foodstuff, e.g., “Cut Carrot Into Bite-Size Chunks” or “Dissolve Mix”. “Cooking Way” represents an action in a cooking step, e.g., “Cut”, “Simmer”, “Fry”, “Stir”, or “Dissolve”. “Foodstuff” represents a foodstuff to be used in a cooking step, e.g., “Carrot” or “Mix”. “Cooking Utensil” represents a cooking utensil to be used in a cooking step, e.g., “Kitchen Knife”, “Pot”, or “Microwave Oven”. “Accomplishment Difficulty” represents a difficulty for accomplishing a cooking step.

In the step information table T11, “Cooking Way” specifies only an action with a coarse granularity, but may specify information other than the action (e.g., a state of a foodstuff or a cooking time) with a finer granularity. For example, “Cooking Way” may have classifications of “Cut Into Bite-Size Chunks” and “Chop Finely” instead of “Cut” only, classifications of “Simmer For X Minutes” and “Simmer For Y Minutes After Simmering For X Minutes” instead of “Simmer” only, a classification of “Whip Heavy Cream Until Creamy State” instead of “Stir” only, a classification of “Wash Until Mud Comes Off” instead of “Wash” only, or a classification of “Deep-Fry Until Golden Brown” instead of “Deep-Fry” only. A step information table T11 in which “Cooking Way” is classified with a fine granularity has respective records on fine-grained classifications for the cooking way, e.g., “Cut Into Bite-Size Chunks” and “Chop Finely”, and specifies respective accomplishment difficulties on the fine-grained classifications for the cooking way.

The determination part 13 may switch between a step information table T11 specifying “Cooking Way” with a coarse granularity and a step information table T11 specifying “Cooking Way” with a fine granularity. For example, the determination part 13 may select the step information table T11 specifying “Cooking Way” with the fine granularity for a user on a paid plan, and the determination part 13 may select the step information table T11 specifying “Cooking Way” with the coarse granularity for a user on a free plan. Further, the determination part 13 may select the step information table T11 specifying “Cooking Way” with the coarse granularity for a user at an age larger than a reference age, and select the step information table T11 specifying “Cooking Way” with the fine granularity for a user at an age not larger than the reference age.

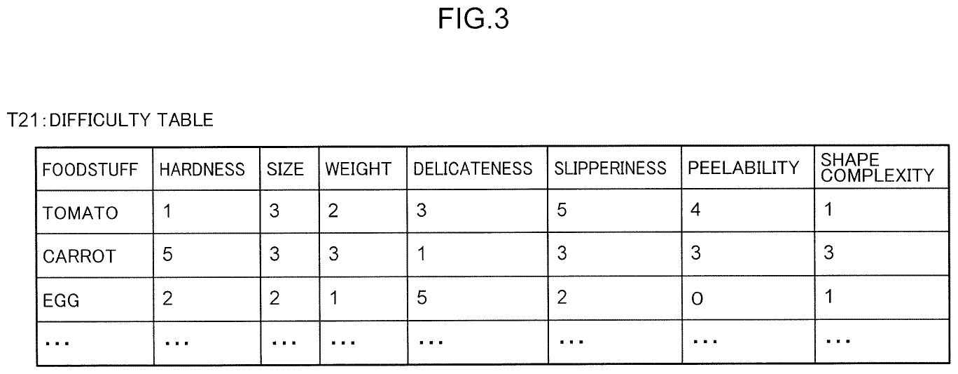

The difficulty information storage part 22 stores difficulty tables T21, T22. FIG. 3 is a difficulty table T21 in an exemplary data configuration. The difficulty table T21 is a table that stores a foodstuff difficulty to be used for calculating the accomplishment difficulty of each of the cooking steps. The difficulty table T21 specifies a foodstuff difficulty for each of a plurality of foodstuff properties of each of foodstuffs. The foodstuff property represents a property related to cooking of a foodstuff, and includes, e.g., “Hardness”, “Size”, “Weight”, “Delicateness”, “Slipperiness”, “Peelability”, and “Shape Complexity”. The foodstuff difficulty represents a difficulty in cooking a foodstuff according to a foodstuff property thereof. The foodstuff difficulty has a predetermined value associated with a foodstuff property; a larger value indicates a higher difficulty. For example, “Tomato” indicates respective foodstuff difficulties “1”, “3”, “2”, “3”, “5”, “4”, and “1” for “Hardness”, “Size”, “Weight”, “Delicateness”, “Slipperiness”, “Peelability”, and “Shape Complexity”. The foodstuff difficulty is an exemplary “first value associated with a feature of a foodstuff”. The foodstuff properties shown in FIG. 3 are mere examples; another foodstuff property can be used.

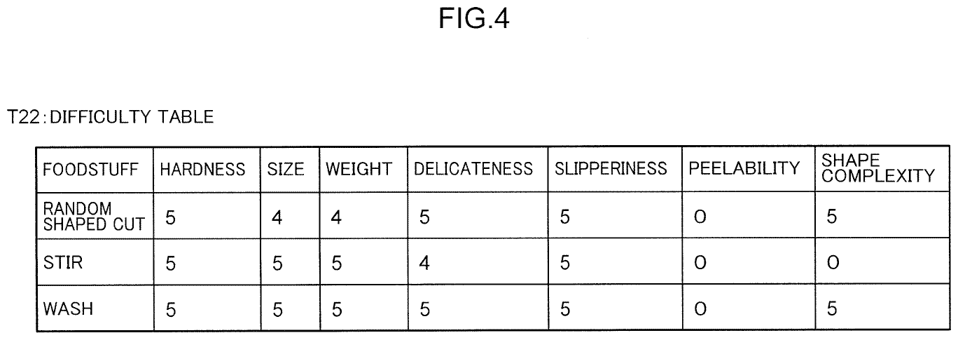

FIG. 4 is a difficulty table T22 in an exemplary data configuration. The difficulty table T22 is a table that stores a weight value to be used for calculating the accomplishment difficulty of each of the cooking steps. The difficulty table T22 specifies a weight value for each of the foodstuff properties with respect to each of cooking ways. “Cooking Way” represents an action in a cooking step, e.g., “Random Shaped Cut” and “Stir”. The difficulty table has the same foodstuff properties as the difficulty table T21 in FIG. 3, i.e., “Hardness”, “Size”, “Weight”, “Delicateness”, “Slipperiness”, “Peelability”, and “Shape Complexity”. The weight value is a predetermined value associated with a foodstuff property; a larger value indicates a higher difficulty. The weight value is an exemplary “second value associated with a feature of a cooking way of a foodstuff”.

In a case where the step information table T11 is a table having fine-grained classifications for “Cooking Way”, the difficulty table T22 has fine-grained classifications for “Cooking Way” corresponding to those classifications, e.g., “Cut Into Bite-Size Chunks” and “Chop Finely”.

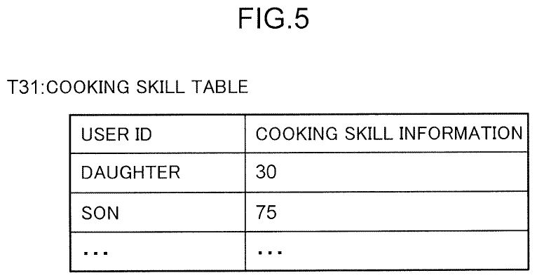

The user information storage part 23 stores a cooking skill table T31. FIG. 5 is a cooking skill table T31 in an exemplary data configuration. The cooking skill table T31 is a table that specifies cooking skill information for each user. The cooking skill table T31 has “User ID” and “Cooking Skill Information”. “User ID” is an identifier for a user, e.g., “Daughter” or “Son”. “User ID” may be a string of symbols uniquely identifying each user. The cooking skill information indicates a cooking skill of each user. A larger value for the cooking skill information indicates a better cooking skill. For convenience of explanation, the cooking skill table T31 herein represents a cooking skill table for one family. In a case where the information processing apparatus 1 covers a plurality of families, there is a cooking skill table for each family. In this case, cooking skill information for a user is specified from a family ID and a user ID.

The cooking skill information for the daughter in this example indicates 30, the daughter can accomplish a cooking step having an accomplishment difficulty not larger than 30. The cooking skill table T31 may store cooking skill information for each “Cooking Way” for each user, e.g., “30” for “Cut” and 20 for “Fry”.

The guardian may judge a cooking skill of the user and provide input about cooking skill information through the user terminal 2. For example, the cooking skill information may be determined from an answer by the guardian to a questionnaire on a cooking skill of the user displayed on the user terminal 2. The questionnaire has a plurality of items, e.g., “Able To Mince Alone”, “Able To Use Stove Alone”, and “Able To Deep-Fry Using Oil Alone”, and the guardian inputs YES, NO, or a value on a scale for the items. The information processing apparatus 1 then receives a result of the questionnaire from the user terminal 2 and calculates the cooking skill information for the user on the basis of the result of the questionnaire.

Alternatively, the information processing apparatus 1 may determine the cooking skill information from sensor information. The sensor information includes, e.g., video data obtained by capturing a cooking scene of the user. The information processing apparatus 1 may calculate the cooking skill information for the user on the basis of a difference between the video data for the user and exemplary video data. For example, the information processing apparatus 1 calculates a difference between a feature of motion of the user in the movie data for the user and a feature of reference motion obtained from the exemplary video data, and calculates the cooking skill information such that the cooking skill information takes a smaller value as the difference becomes greater.

Alternatively, the cooking skill information may be acquired from an external database. The external database includes, e.g., a database managed by a server in a system that provides a service different from that of the information processing system. The different service includes, e.g., a cooking assistance service that keeps cooking skill information for a user, proposes a recipe appropriate to the user on the basis of the cooking skill information, and instructs the user how to make a dish on the basis of the proposed recipe.

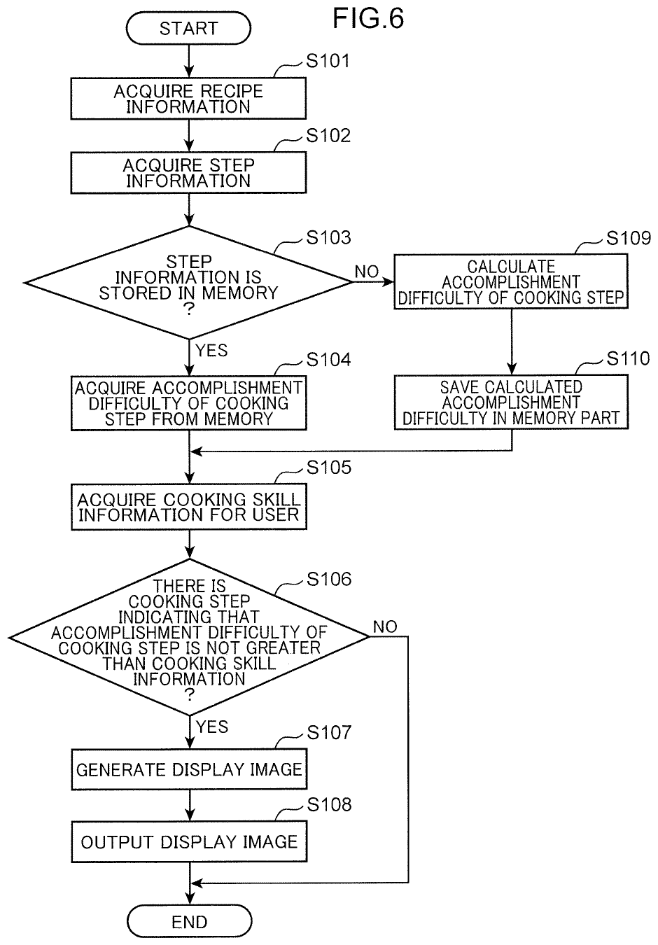

FIG. 6 is a flowchart showing an exemplary process of the information processing apparatus 1 according to the first embodiment.

### Step S101

The recipe information acquisition part 11 acquires recipe information transmitted from the user terminal 2. The pattern of input of the recipe information to the user terminal 2 is as follows.

The user terminal 2 may acquire recipe information input by the guardian. The recipe information to be input includes at least one of text data of a recipe, video data for the recipe, and still image data for the recipe. The text data of the recipe may be data manually input by the user. The video data for the recipe is video data representing a recipe acquired by the guardian from an external server, or may be video data obtained by the guardian capturing a situation of cooking according to the recipe. The still image data for the recipe is still image data representing the recipe acquired by the guardian from the external server, or may be still image data obtained by the guardian capturing the situation of cooking according to the recipe. The still image data representing the recipe acquired from the external server may be a screenshot from the video data representing the situation of cooking according to the recipe. For example, movie data or still image data obtained by capturing a cooking mother can be used for a case where a father as the supervisor allows a user (child) to provide help with cooking.

The user terminal 2 may acquire a picture of a recipe book taken by the guardian, acquire recipe information by converting the picture into text data, and transmit the acquired recipe information to the information processing apparatus 1.

In Step S101, a user ID for a user to provide help is acquired in addition to the recipe information.

### Step S102

The extraction part 12 extracts step information from the recipe information. The step information includes at least the foodstuff information and the foodstuff cooking information among the foodstuff information, the foodstuff cooking information, and the utensil information. In a case where the recipe information includes text data, the extraction part 12 divides the text data into a plurality of cooking steps and applies the morphological analysis to the text data of each of the cooking steps to thereby identify a verb, an object, a complement, and a modifier included in the text data of each of the cooking steps. From a result of the identification, the extraction part 12 extracts a cooking step and a cooking way as the foodstuff cooking information, a foodstuff as the foodstuff information, and a utensil as the utensil information, which are to be used in each of the cooking steps. For example, text data of “Cut Carrot Into Bite-Size Chunks With Kitchen Knife” is divided into “Kitchen Knife”, “Carrot”, “Into Bite-Size Chunks”, and “Cut” by the morphological analysis, and “Kitchen Knife”, “Carrot”, “Cut”, and “Cut Into Bite-Size Chunks” are extracted as the cooking utensil, the foodstuff, the cooking way, and the cooking step, respectively.

In a case where the recipe information has image data, i.e., the video data or the still image data, the extraction part 12 identifies motion of a cook by applying a skeleton detection process to the image data, and classifies the image data included in the recipe information for each of the cooking steps on the basis of the identified motion. The extraction part 12 applies an object detection process and the skeleton detection process to the classified image data for each of the cooking steps to thereby extract a cooking step, a cooking way, a foodstuff, and a cooking utensil as step information.

The extraction part 12 may not extract a cooking utensil in a case where text data or image data for a cooking step does not contain a cooking utensil.

### Step S103

The determination part 13 determines whether the step information extracted from the recipe information is stored in the memory 20. In a case where the step information table T11 has step information indicative of “Cooking Step”, “Cooking Way”, “Foodstuff”, and “Cooking Utensil” corresponding to those included in the extracted step information, the determination part 12 determines that the corresponding step information is stored in the memory 20. On the other hand, in a case where the step information table T11 has no step information indicative of “Cooking Step”, “Cooking Way”, “Foodstuff”, and “Cooking Utensil” corresponding to those included in the extracted step information, the determination part 12 determines that the corresponding step information is not stored in the memory 20. For example, in a case where step information indicates “Cut Carrot Into Bite-Size Chunks” as “Cooking Step”, “Cut” as “Cooking Way”, “Carrot” as “Foodstuff”, and “Kitchen Knife” as “Cooking Utensil”, it is determined that the corresponding step information is included in the step information table T11.

In a case where the extracted step information involves no cooking utensil, the determination part 13 determines, if the step information table T11 has step information indicative of corresponding “Cooking Step”, “Cooking Way”, and “Foodstuff”, that the corresponding step information is stored in the memory 20. The determination part 13 may determine, in a case where the step information table T11 has step information indicative of at least corresponding “Cooking Way” and “Foodstuff” among “Cooking Step”, “Cooking Way”, “Foodstuff”, and “Cooking Utensil” included in the extracted step information, that the corresponding step information is stored in the memory 20.

In a case where a result of the determination in Step S103 indicates YES, the process proceeds to Step S104; in a case where the result of the determination in Step S103 indicates NO, the process proceeds to Step S109.

### Step S104

The determination part 13 acquires an accomplishment difficulty of the cooking step associated with the extracted step information from the memory 20. For example, in a case where the extracted step information indicates “Cut Carrot Into Bite-Size Chunks” as “Cooking Step”, “Cut” as “Cooking Way”, “Carrot” as “Foodstuff”, and “Kitchen Knife” as “Cooking Utensil”, an accomplishment difficulty of “69” for “Cut Carrot Into Bite-Size Chunks” is acquired from the step information table T11.

### Step S109

The determination part 13 calculates an accomplishment difficulty of the cooking step associated with the extracted step information, specifically, as follows. First, the determination part 13 acquires from the difficulty table T21 a foodstuff difficulty for a foodstuff indicated by the foodstuff information included in the extracted step information. For example, in a case where the foodstuff information indicates “Tomato”, a foodstuff difficulty for the tomato is acquired from the difficulty table T21.

The determination part 13 then acquires a weight value associated with the cooking way included in the step information from the difficulty table T22. For example, in a case where the cooking way indicates “Random shaped Cut”, a weight value for each foodstuff property associated with “Random Shaped Cut” is acquired from the difficulty table T22.

The determination part 13 calculates the accomplishment difficulty of the cooking step associated with the step information by calculating a weighted sum using the accomplishment difficulty acquired from the difficulty table T21 and the weight value acquired from the difficulty table T22. For example, an accomplishment difficulty of 70=1·5+3·4+2·4+3·5+5·5+4·0+1·5 is calculated for the cooking step of the random shaped cut of the tomato. In the first term of “1·5”, “1” represents a foodstuff difficulty for the hardness of the tomato, and “5” represents a weight value for the hardness associated with the random shaped cut. In the second term of “3·4”, “3” represents a foodstuff difficulty for the size of the tomato, and “4” represents a weight value for the size associated with the random shaped cut. In the third term of “2·4”, “2” represents a foodstuff difficulty for the weight of the tomato, and “4” represents a weight value for the weight associated with the random shaped cut. In the fourth term of “3·5”, “3” represents a foodstuff difficulty for the delicateness of the tomato, and “5” represents a weight value for the delicateness associated with the random shaped cut. In the fifth term of “5·5”, “5” represents a foodstuff difficulty for the slipperiness of the tomato, and “5” represents a weight value for the slipperiness associated with cut with the kitchen knife. In the sixth term of “4·0”, “4” represents a foodstuff difficulty for the peelability of the tomato, and “0” represents a weight value for the peelability associated with the random shaped cut. In the seventh term of “1·5”, “1” represents a foodstuff difficulty for the shape complexity of the tomato, and “5” represents a weight value for the shape complexity associated with the random shaped cut.

As described above, the accomplishment difficulty is obtained by multiplying a foodstuff difficulty acquired from the difficulty table T21 and a weight value acquired from the difficulty table T22 for each of the foodstuff properties and summing the values obtained by the multiplication.

### Step S110

The determination part 13 saves the calculated accomplishment difficulty in the memory 20. For example, the determination part 13 adds a new record including step information with the calculated accomplishment difficulty to the step information table T11, and saves the calculated accomplishment difficulty in a field for “Accomplishment Difficulty” of the added record.

### Step S105

The user information acquisition part 14 acquires cooking skill information for a user associated with the user ID acquired in Step S101 from the cooking skill table T31. For example, “30” is acquired as the cooking skill information for a user ID of “Daughter”. In a case where a plurality of users provides help, cooking skill information for each of the users is acquired.

### Step S106

The determination part 13 determines whether there is a cooking step indicating an accomplishment difficulty not greater than the cooking skill information for the user among the cooking steps included in the recipe information. In a case where it is determined that there is an accomplishable cooking step that is a cooking step indicating an accomplishment difficulty not greater than the cooking skill information (YES in Step S106), the process proceeds to Step S107; in a case where it is determined that there is no accomplishable cooking step (NO in Step S106), the process ends.

### Step S107

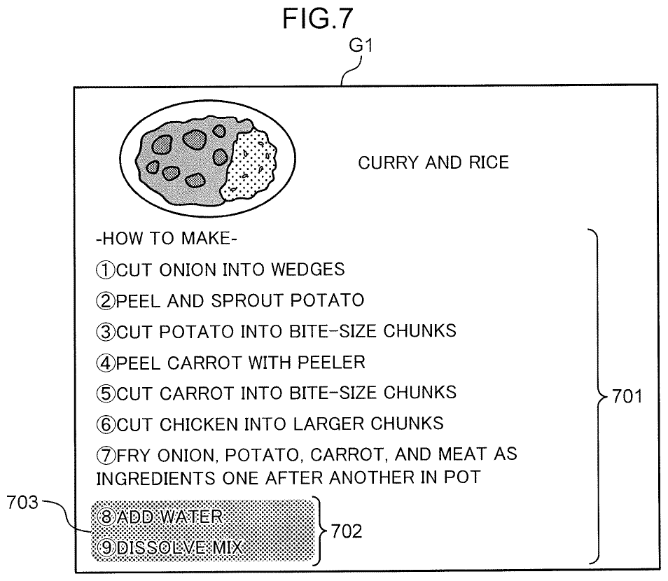

The generation part 15 generates a display image having accomplishable cooking information indicative of the accomplishable cooking step superimposed on a display field for the accomplishable cooking step in display fields for the cooking steps included in the recipe information. FIG. 7 is an illustration showing an exemplary display image G1. The exemplary display image G1 shows a recipe of curry and rice. The display image G1 includes display fields 701 and a display field 702. The display fields 701 are display fields for a plurality of cooking steps included in the recipe of curry and rice. The display fields 701 list the cooking steps, e.g., “Cut Onion Into Wedges” and “Peel And Sprout Potato”.

The display field 702 is a field for an accomplishable cooking step for a user. The display field 702 has accomplishable cooking information 703 superimposed thereon to distinguish the accomplishable cooking step from the other cooking steps. The accomplishable cooking information 703 includes, e.g., a highlight image, but this is merely an example; the accomplishable cooking information 703 may be an underline, or a square surrounding the accomplishable cooking step. In the example in FIG. 5, the cooking skill information for the user as daughter indicates “30” and the accomplishment difficulties of cooking steps of “Add Water” and “Dissolve Mix” are not more than “30”; therefore, the accomplishable cooking information 703 is superimposed on display fields 702 for these steps.

A generation of a display image G1 in the generation part 15 means a generation of display data for causing the display terminal 3 to display the display image G1. In a case of NO in Step S106, the generation part 15 generates a display image G1 without superimposition of the accomplishable cooking information. In this case, the display terminal 3 displays the display image G1 without superimposition of the accomplishable cooking information.

### Step S108

The output part 16 outputs the display data for the display image G1 to the display terminal 3 through the communication part 30. Thus, the display terminal 3 shows the display image G1 on the display. Since the accomplishable cooking step is highlighted in the display image G1, the guardian can easily recognize a cooking step that may involve help by the user. The user also can easily recognize the cooking step with which the user can provide help. Thus, help by the user can be facilitated.

### Modification (1) of First Embodiment

In Step S102, the cooking way may be estimated from the utensil information. For example, in a case where “Kitchen Knife” is extracted from the recipe information, the extraction part 12 estimates that the cooking way is “Cut”, because “Kitchen Knife” is used for cutting. If “Carrot” is extracted as the foodstuff for this case, the extraction part 12 extracts a cooking step “Cut Carrot” from a combination of “Cut”, “Kitchen Knife”, and “Carrot”. The extraction part 12 extracts “Cut Carrot” and the cooking way as the foodstuff cooking information. The extraction part 12 estimates the cooking way from the utensil information by referring to an estimation table for the cooking way stored in the memory 20. The estimation table for the cooking way stores utensil information and a cooking way in association with each other, e.g., “Cut” associated with “Kitchen Knife”, “Simmer” associated with “Pot”, or “Fry” associated with “Frying Pan”.

### Modification (2) of First Embodiment

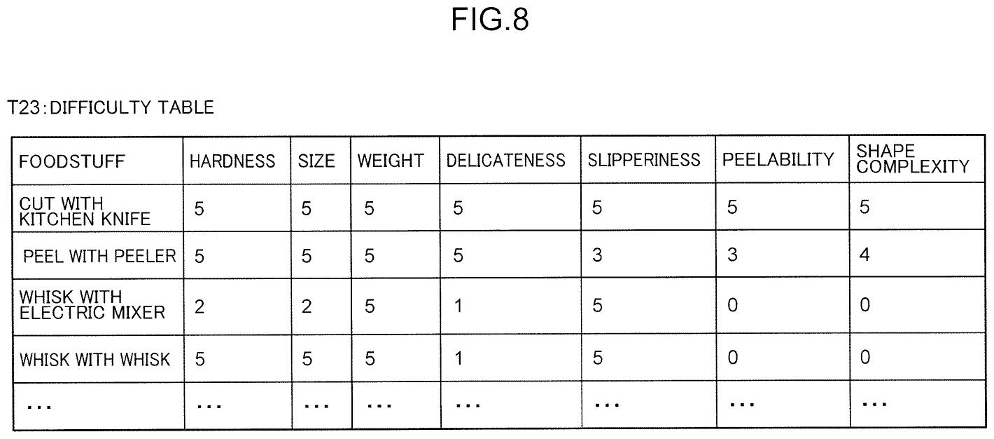

In the modification (2) of the first embodiment, a difficulty table T23 in FIG. 8 is used in Step S109, instead of the difficulty table T22. FIG. 8 is a difficulty table T23 in an exemplary data configuration in the modification (2) of the first embodiment. The difficulty table T23 specifies “Cooking Way” not on the basis of an action only, but on the basis of a combination of an action and a cooking utensil, e.g., “Cut With Kitchen Knife”, “Peel with Peeler”, “Whisk With Electric Mixer”, or “Whisk With Whisk”.

In the modification (2), the determination part 13 acquires a foodstuff difficulty for a foodstuff indicated by foodstuff information included in the step information from the difficulty table T21. The determination part 13 then acquires from the difficulty table T23 a weight value for “Cooking Way” represented by a combination of the action and the cooking utensil extracted as described above.

The determination part 13 then calculates the accomplishment difficulty of the cooking step associated with the step information by calculating a weighted sum using the foodstuff difficulty acquired from the difficulty table T21 and the weight value acquired from the difficulty table T23. For example, in a case where the foodstuff is “Tomato” and the cooking way is “Cut With Kitchen Knife”, the accomplishment difficulty becomes 95=1·5+3·5+2·5+3·5+5·5+4·5+1·5.

In the first term of “1·5”, “1” represents a foodstuff difficulty for the hardness of the tomato, and “5” represents a weight value for the hardness associated with the cut with the kitchen knife. In the second term of “3·5”, “3” represents a foodstuff difficulty for the size of the tomato, and “5” represents a weight value for the size associated with the cut with the kitchen knife. In the third term of “2·5”, “2” represents a foodstuff difficulty for the weight of the tomato, and “5” represents a weight value for the weight associated with the cut with the kitchen knife. In the fourth term of “3·5”, “3” represents a foodstuff difficulty for the delicateness of the tomato, and “5” represents a weight value for the delicateness associated with the cut with the kitchen knife. In the fifth term of “5·5”, “5” represents a foodstuff difficulty for the slipperiness of the tomato, and “5” represents a weight value for the slipperiness associated with the cut with the kitchen knife. In the sixth term of “4·5”, “4” represents a foodstuff difficulty for the peelability of the tomato, and “5” represents a weight value for the peelability associated with the cut with the kitchen knife. In the seventh term of “1·5”, “1” represents a foodstuff difficulty for the shape complexity of the tomato, and “5” represents a weight value for the shape complexity associated with the cut with the kitchen knife.

The step information table T11 for this configuration specifies “Cooking Way” not on the basis of an action only, but on the basis of a combination of an action and a cooking utensil, e.g., “Cut With Kitchen Knife”, “Peel with Peeler”, “Whisk With Electric Mixer”, or “Whisk With Whisk”, and has a record for each “Cooking Way” as specified above. Therefore, the accomplishment difficulty is calculated based on each “Cooking Way” specified on the basis of the combination of the action and the cooking utensil.

### Modification (3) of First Embodiment

In the modification (3), in Step S109, the determination part 13 calculates the accomplishment difficulty by combining a first accomplishment difficulty calculated from the difficulty table T21 and the difficulty table T22, and a second accomplishment difficulty calculated from the difficulty table T21 and the difficulty table T23. For example, an average of the first accomplishment difficulty and the second accomplishment difficulty is determined as the accomplishment difficulty.

### Modification (4) of First Embodiment

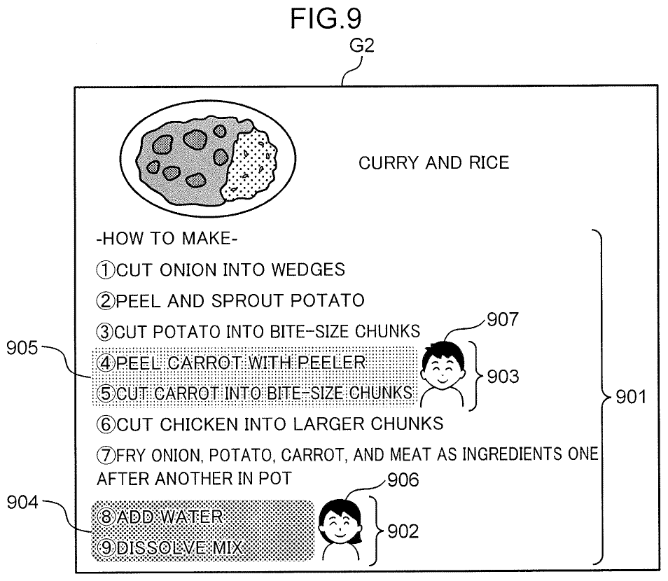

The generation part 15 may generate a display image having accomplishable cooking information for each of a plurality of users superimposed thereon. FIG. 9 is an illustration showing an exemplary display image G2 in the modification (4) of the first embodiment of the present disclosure.

The display image G2 has display fields 901, 902, and 903. The display fields 901 correspond to the display fields 701. The display field 902 is a display field for an accomplishable cooking step for a daughter as the user (first user). The display field 903 is a display field for an accomplishable cooking step for a son as the user (second user).

The display field 902 has accomplishable cooking information 904 superimposed thereon to distinguish the accomplishable cooking step for the first user from the other cooking steps. The display field 903 has accomplishable cooking information 905 superimposed thereon to distinguish the accomplishable cooking step for the second user from the other cooking steps. The accomplishable cooking information 904 and the accomplishable cooking information 905 are represented in different colors, e.g., as a red highlight image and a blue highlight image, respectively. Additionally, the display field 902 has an icon 906 indicative of the first user, and the display field 903 has an icon 907 indicative of the second user; this configuration enables easily recognizing which display field corresponds to which user. In this example, since the cooking skill information for the second user is higher than the cooking skill information for the first user, the second user can accomplish the accomplishable cooking step for the first user; nevertheless, only the accomplishable cooking information 904 for the first user with the lower cooking skill information is superimposed on the display field 902 for the cooking step accomplishable by both of the first user and the second user, in order to allow both of the first user and the second user to evenly provide help.

To realize this, the determination part 13 determines whether there is an accomplishable cooking step for each user. The generation part 15 determines an accomplishable cooking step for each of the first user and the second user by comparing each of the cooking skill information for the first user and the cooking skill information for the second user with the accomplishment difficulty of each of the cooking steps. The generation part 15 superimposes the accomplishable cooking information 904 for the first user on the display field 902 for the accomplishable cooking step that is accomplishable by both of the first user and the second user, and superimposes the accomplishable cooking information 905 for the second user on the display field 903 for the accomplishable cooking step that is accomplishable only by the second user.

The generation part 15 may generate a first display image for the first user in which only the accomplishable cooking information 904 is superimposed on the display field 902 for the accomplishable cooking step for the first user, and a second display image for the second user in which only the accomplishable cooking information 905 is superimposed on the display field 903 for the accomplishable cooking step for the second user.

In this configuration, the output part 16 may output the first display image to a display terminal 3 of the first user, and output the second display image to a display terminal 3 of the second user. Since the display terminal 3 of the first user shows the first display image, the first user can easily recognize the cooking step with which the first user can provide help. Since the display terminal 3 of the second user shows the second display image, the second user can easily recognize the cooking step with which the second user can provide help. Alternatively, the output part 16 may cause a display terminal 3 to show a display image switchable between the first display image and the second display image. In this configuration, the display terminal 3 switches the first display image and the second display image to display either according to an order by the first user, the second user, or the guardian.

### Modification (5) of First Embodiment

(1) The processes of Steps S103, S109, and S110 in the flowchart of FIG. 6 may be omitted. In this case, the determination part 13 calculates an accomplishment difficulty of a cooking step every time without determining whether certain step information is stored in the step information table T11.

The modifications (1) to (5) of the first embodiment are applicable to embodiments described below.

### Second Embodiment

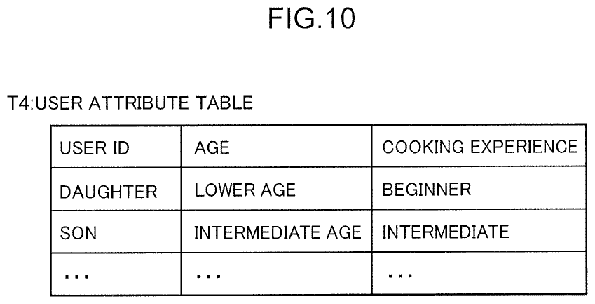

The second embodiment involves determination as to whether there is an accomplishable cooking step, based on an accomplishment rate associated with an attribute of a user as the accomplishment difficulty for the user. In this embodiment, the same constituents as those in the first embodiment are denoted by the same reference numerals, and the description thereof will be omitted. In the second embodiment, the memory 20 stores a user attribute table T4 and an attribute information table T5. FIG. 10 is a user attribute table T4 in an exemplary data configuration.

The user attribute table T4 is a table storing an attribute of each user. The attribute includes an attribute “Age” and an attribute “Cooking Experience”. The attribute “Age” includes, e.g., attributes of a higher age, an intermediate age, and a lower age. The lower age, the intermediate age, and the higher age correspond to respective three age groups obtained by dividing an age group ranging, e.g., from zero to eighteen years old. The attribute “Age” may include classified age groups corresponding to, e.g., a kindergartner, an elementary school student in a lower grade, an elementary school student in a middle grade, an elementary school student in a higher grade, a junior high school student, and a high school student.

The attribute “Age” is defined according to information input by the guardian through the user terminal 2.

The attribute “Cooking Experience” is relevant to the cooking skill, and includes, e.g., attributes of the beginner, the intermediate, and the advanced. The attribute “Cooking Experience” is defined according to information input by the guardian through the user terminal 2. Alternatively, the attribute “Cooking Experience” may be acquired from the sensor information or the external database.

The sensor information includes video data obtained by capturing a cooking scene of the user. The information processing apparatus 1 may determine, on the basis of a difference between the video data for the user and the exemplary video data, to which of the attributes of the beginner, the intermediate, and the advanced the user corresponds, and store a result of the determination in the user attribute table T4. The difference may be the difference as described above, i.e., between the feature of motion of the user and the feature of exemplary motion.

Alternatively, the attribute “Cooking Experience” may be determined from the number of times the user cooks that is kept by the information processing apparatus 1. For example, the information processing apparatus 1 determines that the user is the beginner, intermediate, or advanced in a case where the number of times the user cooks that is stored in the memory 20 is not greater than a first reference number of times, is greater than the first reference number of times and not greater than a second reference number of times, or is greater than the second reference number of times, respectively.

Alternatively, the attribute “Cooking Experience” may be acquired from the external database. The external database is as described above, i.e., the database managed by the server in the system that provides the different service. In this case, the external database keeps, e.g., information indicating that a user is the beginner, intermediate, or advanced, and provides the information processing apparatus 1 with this information.

For convenience of explanation, the user attribute table T4 herein represents a user attribute table for one family. In a case where the information processing apparatus 1 covers a plurality of families, there may be a user attribute table for each family. In this case, the attribute “Age” and the attribute “Cooking Experience” for a user are specified from a family ID and a user ID.

In this example, the attribute “Cooking Experience” has three classifications, but this is merely an example. The attribute may have two classifications, or four or more classifications.

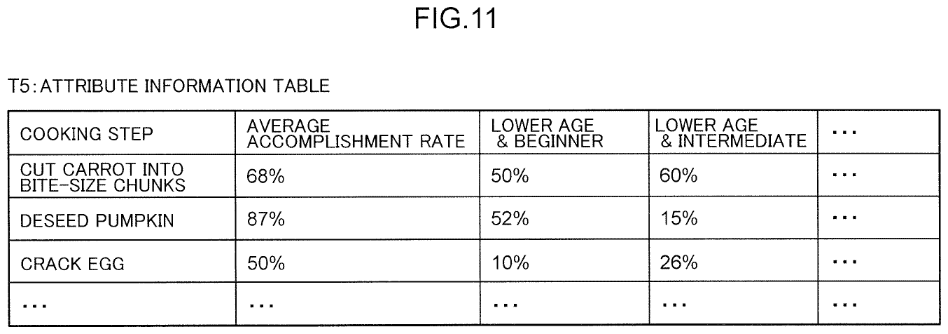

FIG. 11 is an attribute information table T5 in an exemplary data configuration. The attribute information table T5 has an average accomplishment rate of each of the cooking steps, and accomplishment rates thereof associated with respective pairs of the attribute “Age” and the attribute “Cooking Experience”. “Cooking Step” is a label representing a cooking step, similarly as in FIG. 2.

“Average Accomplishment Rate” refers to an average value of accomplishment rates of a cooking step by unspecified users. The unspecified user refers to a user covered by the present information processing system.

The pairs of the attribute “Age” and the attribute “Cooking Experience” refer to all combinations of classifications for the attribute “Age” and classifications for the attribute “Cooking Experience”. Thus, a multiplication of three classifications for the attribute “Age” and three classifications for the attribute “Cooking Experience” results in nine combinations for the attribute “Age” and the attribute “Cooking Experience”, such as “Lower Age & Beginner” and “Lower Age & Intermediate”.

For example, the accomplishment rate of the cooking step “Cut Carrot Into Bite-Size Chunks” for “Lower Age & Beginner” is 50%, and the accomplishment rate thereof for “Lower Age & Intermediate” is 60%. The accomplishment rate is an average value of accomplishment rates by unspecified users associated with a pair of the attribute “Age” and the attribute “Cooking Experience”. The accomplishment rate of a cooking step is calculated by totalizing cooking results each indicating whether an unspecified user has succeeded in cooking. For example, an accomplishment rate of a cooking step which 50 among 100 unspecified users have successfully completed is 50%.

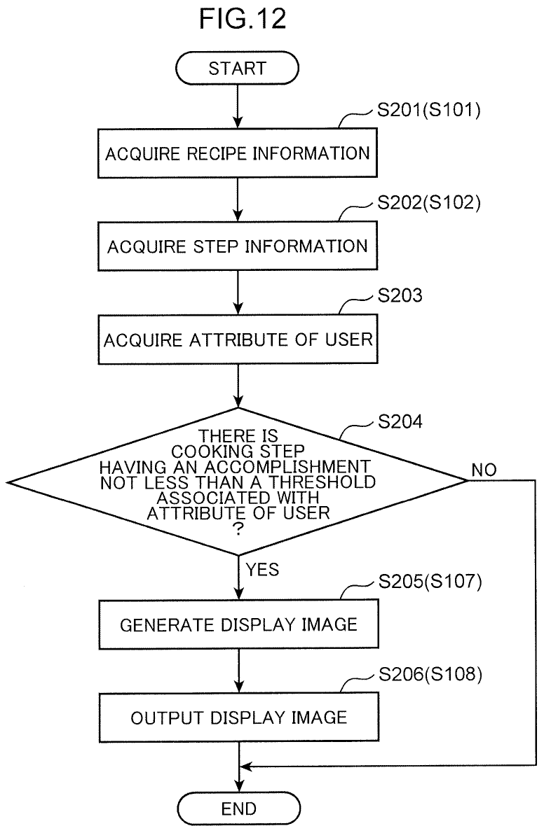

FIG. 12 is a flowchart showing an exemplary process of the information processing apparatus 1 according to the second embodiment. Steps S201, S202, S205, and S206 are the same as Steps S101, S102, S107, and S108 in FIG. 6, respectively.

### Step S203

The determination part 13 acquires an attribute “Age” and an attribute “Cooking Experience” for a target user from the user attribute table. For example, for a user having a user ID “Daughter”, “Lower Age” and “Beginner” are acquired as the attribute “Age” and the attribute “Cooking Experience”, respectively.

### Step S204

The determination part 13 determines whether there is a cooking step having a threshold not more than an accomplishment rate associated with the attribute of the user among the cooking steps included in the recipe information. Specifically, the determination part 13 acquires an accomplishment rate associated with the attribute “Age” and the attribute “Cooking Experience” for each of the cooking steps included in the recipe information from the attribute information table T5. For example, since the exemplary user as daughter described above indicates “Lower Age” as the attribute “Age”, and “Beginner” as the attribute “Cooking Experience”, the accomplishment rate “52%” is acquired for a cooking step “Deseed Pumpkin”. In a case where the threshold is, e.g., “50%”, it is determined that the user “Daughter” can accomplish “Deseed Pumpkin”, for the accomplishment rate of “Deseed Pumpkin” is “52%” in the example described above.

In a case where there is at least one cooking step having an accomplishment rate not less than a threshold (YES in Step S204), the process proceeds to Step S205; in a case where there is no cooking step having an accomplishment rate not less than a threshold (NO in Step S204), the process ends.

The threshold may be arbitrarily changed by the guardian or a leader in the cooking.

As described above, in the second embodiment, among accomplishment rates each of which is predetermined on the basis of an accomplishment result of each of the cooking steps by an unspecified user and is associated with an attribute, an accomplishment rate associated with an attribute of the user is recognized as an accomplishment rate for the user, and the accomplishment rate is compared with a threshold to determine a cooking step accomplishable by the user. Therefore, a cooking step accomplishable by a target user can be easily determined without keeping of each accomplishment rate for the user.

### Third Embodiment

The third embodiment involves acquisition of a cooking result of a cooking operation completed by the user and modification of the cooking skill information based on the cooking result. In this embodiment, the same constituents as those in the first embodiment are denoted by the same reference numerals, and the description thereof will be omitted.

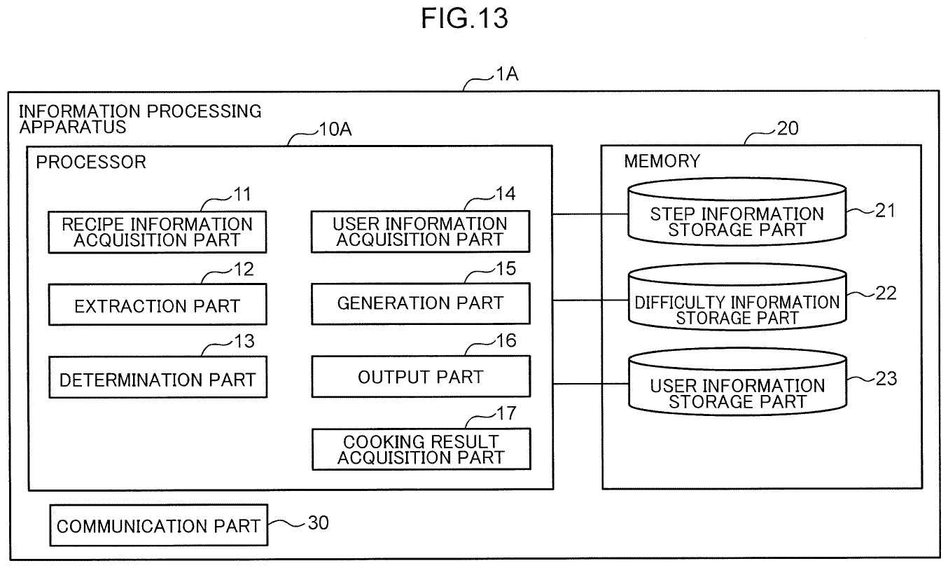

FIG. 13 is a block diagram showing an exemplary structure of an information processing apparatus 1A according to the third embodiment of the present disclosure. The processor 10A further includes a cooking result acquisition part 17. The cooking result acquisition part 17 acquires a cooking result for a user transmitted from the user terminal 2 through the communication part 30. The cooking result acquisition part 17 modifies the cooking skill information for the user on the basis of the acquired cooking result.

The cooking result refers to a cooking result indicating that cooking has ended in success and a cooking result indicating that cooking has ended in failure.

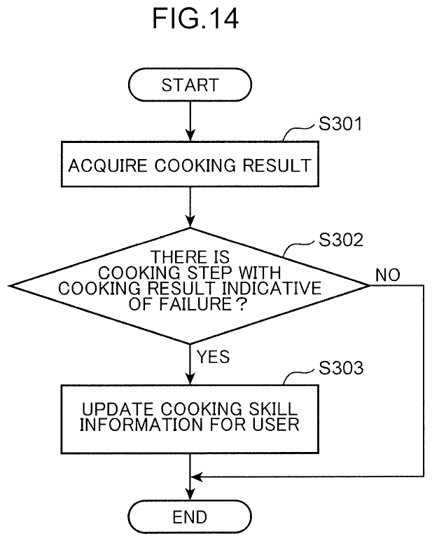

FIG. 14 is a flowchart of an exemplary process in the third embodiment of the present disclosure. This process in the flowchart is executed, for example, after the user finished cooking.

### Step S301

The cooking result acquisition part 17 acquires a cooking result transmitted from the user terminal 2. The guardian may input the cooking result by operating the user terminal 2. For example, the cooking result acquisition part 17 causes the user terminal 2 to display an input screen for a cooking result, when detecting completion of cooking by the user. The input screen for the cooking result has, e.g., a message saying “The cooking for today was successful?”, and a field for inputting a cooking result of each of the cooking steps included in the recipe information. The guardian inputs a cooking result of each of the cooking steps while viewing the input screen, and transmits the input cooking results from the user terminal 2 to the information processing apparatus 1.

Alternatively, the cooking result may be represented by sensor information. The sensor information includes, e.g., video data obtained by capturing a cooking scene of the user with a camera. For example, the cooking result acquisition part 17 analyzes the video data, specifies motion of the user, and specifies a cooking step from the motion. If the motion of the user meets a success condition predetermined for the cooking step, the cooking step is determined to indicate success; if the motion does not meet the success condition, the cooking step is determined to have ended in failure. The success condition is, e.g., that the cooking has been completed within a predetermined time, the user has completed a cooking step without abandoning it, the user has not got injured, or the user has completed a cooking step without intervention by the guardian.

### Step S302

The cooking result acquisition part 17 determines whether there is at least one cooking step with a cooking result indicative of failure among the cooking steps included in the recipe information. In a case where there is at least one cooking step with the cooking result indicative of failure (YES in Step S302), the process proceeds to Step S303; in a case where there is no cooking step with the cooking result indicative of failure (NO in Step S302), the process ends.

### Step S303

The cooking result acquisition part 17 updates the cooking skill information for the user. For example, in a case where the cooking skill information for the user is “30” and the accomplishment difficulty of a cooking step in which the user has failed is “28”, the cooking skill information for the user is changed to a value (e.g., 27) smaller than “28” so that the cooking step is no longer determined to be accomplishable by the user.

The cooking result acquisition part 17 may change the accomplishment difficulty in the step information table T11 so that the cooking step is no longer determined to be accomplishable by the user, instead of updating the cooking skill information for the user. For example, in a case where the cooking skill information for the user is “30” and the accomplishment difficulty of a cooking step in which the user has failed is “28”, the cooking result acquisition part 17 changes a value of the accomplishment difficulty of the cooking step in the step information table T11 to that larger than “30”, e.g., “31”. Alternatively, the cooking result acquisition part 17 may increase weight values in the difficulty table T22 or the difficulty table T23 that are associated with the cooking step by predetermined values, instead of changing the cooking skill information for the user.

As described above, in the third embodiment, cooking skill information for a user is modified in consideration of a cooking result. Thus, accuracy in determination of a cooking step accomplishable by the user can be improved.

### Modification of Third Embodiment

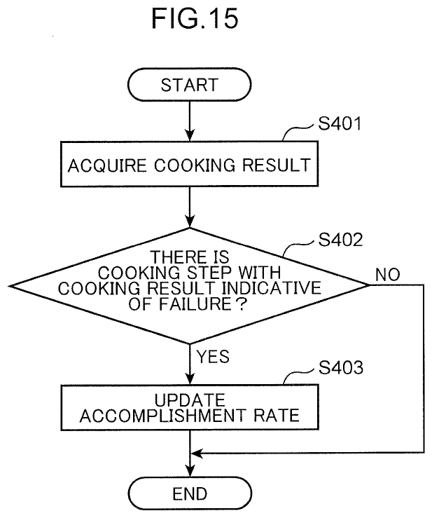

The process in the third embodiment may be applied to the second embodiment. FIG. 15 is a flowchart showing an exemplary process of the information processing apparatus 1A in a modification of the third embodiment. Steps S401 and S402 are the same as Steps S301 and S302, respectively.

### Step S403

The cooking result acquisition part 17 decreases by a predetermined value an accomplishment rate of a cooking step in which the user has failed, the accomplishment rate being associated with the attribute “Age” and the attribute “Cooking Experience” of the user. In a case where a threshold to be used in Step S204 is kept for each user, the cooking result acquisition part 17 increases the threshold for a specific user so that a cooking step having ended in failure is no longer determined to be accomplishable. For example, in a case where a threshold for a user is “50%” and an accomplishment rate of a cooking step in which the user has failed, the accomplishment rate being associated with the attribute “Age” and the attribute “Cooking Experience” of the user, is 52%, the cooking result acquisition part 17 changes the threshold for the user to a value larger than 52% (e.g., 53%).

### Modifications

In the present disclosure, the following modifications may be implemented.

(1) The guardian may enter a setting of prohibiting the accomplishable cooking information from being superimposed on a display field for a specific cooking step. For example, in a case where the generation part 15 acquires from the user terminal 2, while the recipe information is input or while the display image G1 is displayed, information that is input by the guardian and requires prohibition against a specific cooking step, the generation part 15 causes the accomplishable cooking information not to be superimposed on a display field for the cooking step, even if the cooking step is accomplishable by the user. For example, in a case where the guardian has other things to do and cannot observe the user very carefully in cooking for today, the guardian may apply a prohibition setting to a cooking step that the guardian judges to be dangerous to the user. For example, the guardian may apply a prohibition setting to a cooking step involving use of a kitchen knife or a cooking step involving use of oil.

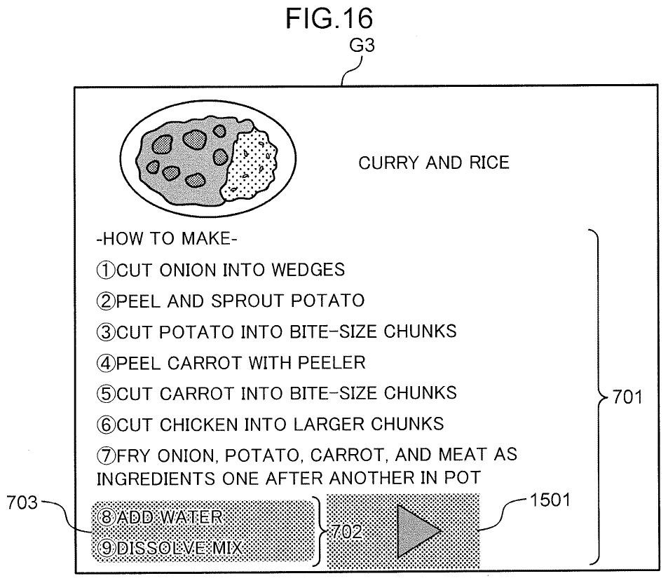

(2) The generation part 15 may generate a display image that allows the user to refer to information including a detailed explanation of an accomplishable cooking step. FIG. 16 is an illustration showing an exemplary display image G3 in the modification (2) of the present disclosure. The display image G3 additionally has a play button 1501 with respect to the display image G1. The play button 1501 is a button placed in the vicinity of the display field 702 for playing a reference video of a cooking step. When the play button 1501 on the display image G3 is tapped, a video image giving a clear explanation of the cooking step in the display field 702 is displayed on the display of the display terminal 3. This configuration reduces a burden on the guardian for explaining a cooking step to the user. The display image G3 may show a still image giving an explanation of a cooking step in the vicinity of the display field 702. For example, in a case where a cooking step “Cut Onion Into Wedges” is determined to be accomplishable, the display image G3 shows a still image of onions cut into wedges in the vicinity of the display field 702.

(3) The generation part 15 may change a standard message giving an explanation of an accomplishable cooking step to a message giving a more detailed explanation. For example, in a case where “Dissolve Mix” is an accomplishable cooking step, a standard message “Dissolve Mix” is changed to “Dissolve Mix Until Block Is No Longer Visible”. In this configuration, the generation part 15 changes the message by referring to a table created in advance and defining an additional message to a standard message for each of the cooking steps. Thus, the user can more easily grasp details of help.

(4) In a case where the determination part 13 determines that all of the cooking steps included in the recipe information are not accomplishable, the generation part 15 may generate a recipe image to suggest a recipe related to an intended cooking recipe and including an accomplishable cooking step by the user. For example, in a case where it is determined that the user cannot accomplish all of the cooking steps for the curry and rice, but can accomplish a step of making a boiled egg, the generation part 15 generates a recipe image for the curry and rice with an additional message saying, e.g., “Since you may have help with a step of making a boiled egg, will you add the boiled egg as a topping onto the curry and rice for today?”, and the output part 16 causes the display terminal 3 to display the generated recipe image.

For example, in a case where it is determined that the user cannot accomplish all of the cooking steps for the Hamburg steak, but can accomplish a cooking step of the random shaped cut of the carrot, the generation part 15 generates a recipe image with an additional message saying, e.g., “Since you may have help with the random shaped cut of the carrot, will you change the Hamburg steak as the menu for today to another menu involving the carrot?”, and the output part 16 causes the display terminal 3 to display the recipe image.

To realize this, the memory 20 stores a recipe candidate table specifying a candidate cooking step to be suggested for each recipe in a case where it is determined that all cooking steps are not accomplishable. The generation part 15 generates, if there is a candidate cooking step accomplishable by the user among the candidate cooking steps specified in the recipe candidate table, a message including a suggestion for the candidate cooking step.

(5) The recipe information acquisition part 11 may show a cooking step accomplishable by the user to the guardian to input the recipe information. For example, in a case where the random shaped cut of the carrot is an accomplishable cooking step, the recipe information acquisition part 11 generates an input screen for the recipe information with a message saying, e.g., “Since you may have help with the random shaped cut of the carrot, a menu involving the carrot is recommended.”, and causes the user terminal 2 to display the input screen.

### INDUSTRIAL APPLICABILITY

The present disclosure can facilitate help by a user with cooking, and thus is useful in a technical field about education of a user through cooking.

1. An information processing method, by a computer, comprising:
(A) acquiring a cooking menu indicative of a cooking way of a foodstuff;
(B) extracting foodstuff information indicative of the foodstuff to be used for the cooking menu and foodstuff cooking information indicative of the cooking way of the foodstuff on the basis of the cooking menu; and
(C) determining an accomplishment difficulty of the cooking menu on the basis of the foodstuff information and the foodstuff cooking information, wherein
the accomplishment difficulty is determined by use of foodstuff property information indicative of two or more properties which are related to cooking of the foodstuff and itemized in both the foodstuff information and the foodstuff cooking information.

2. The information processing method according to claim 1, wherein
the cooking menu includes a plurality of cooking steps, and
in (C), an accomplishment difficulty of each of the cooking steps is determined.

3. The information processing method according to claim 1, wherein
in (C),
a first value associated with the foodstuff property information is acquired on the basis of the foodstuff information,
a second value associated with the foodstuff property information is acquired on the basis of the foodstuff cooking information, and
the accomplishment difficulty of the cooking menu is determined by combining the first value and the second value with each other.

4. The information processing method according to claim 1, wherein
in (B),
utensil information indicative of a utensil to be used for cooking the foodstuff is extracted from the cooking menu, and
estimation information indicative of a cooking way that is estimated on the basis of the utensil information for the foodstuff is acquired as the foodstuff cooking information.

5. The information processing method according to claim 2, wherein
in (B), utensil information indicative of a utensil to be used for cooking the foodstuff is further extracted from the cooking menu, and
in (C), an accomplishment difficulty of each of the cooking steps is determined on the basis of the foodstuff information, the foodstuff cooking information, and the utensil information.

6. The information processing method according to claim 2, further comprising:
(D) acquiring cooking skill information for a target user; and
(E) determining whether each of the cooking steps is accomplishable by the target user on the basis of the cooking skill information and the accomplishment difficulty of each of the cooking steps.

7. The information processing method according to claim 2, further comprising:
(D) acquiring, from an attribute database including an accomplishment rate of each of the cooking steps by an unspecified user associated with each attribute of the unspecified user, an accomplishment rate associated with an attribute of a target user as the accomplishment difficulty; and
(E) determining, in a case where there is a cooking step having an acquired accomplishment difficulty not less than a threshold, that the target user is capable of accomplishing the cooking step.

8. The information processing method according to claim 6, further comprising:
(F) generating, in a case where there is an accomplishable cooking step that is determined to be a cooking step accomplishable by the target user, a display image having accomplishable cooking information indicative of the accomplishable cooking step superimposed on a display field for the accomplishable cooking step in display fields for the cooking steps; and
(G) outputting the display image.

9. The information processing method according to claim 8, wherein
the target user includes a first target user and a second target user,
the accomplishable cooking information includes first accomplishable cooking information indicative of an accomplishable cooking step by the first target user and second accomplishable cooking information indicative of an accomplishable cooking step by the second target user, and
the display image includes an image having, in the display fields for the cooking steps, the first accomplishable cooking information superimposed on a display field for the accomplishable cooking step by the first target user and the second accomplishable cooking information superimposed on a display field for the accomplishable cooking step by the second target user.

10. The information processing method according to claim 8, wherein
the target user includes a first target user and a second target user,
the accomplishable cooking information includes first accomplishable cooking information indicative of an accomplishable cooking step by the first target user and second accomplishable cooking information indicative of an accomplishable cooking step by the second target user, and
the display image includes a first display image having the first accomplishable cooking information superimposed on a display field for the accomplishable cooking step by the first target user in the display fields for the cooking steps and a second display image having the second accomplishable cooking information superimposed on a display field for the accomplishable cooking step by the second target user in the display fields for the cooking steps.

11. The information processing method according to claim 6, further comprising:
(H) acquiring a cooking result of a cooking operation that is included in the cooking menu and completed by the target user; and
(I) modifying the cooking skill information for the target user on the basis of the cooking result, wherein
in (D), the modified cooking skill information is acquired as the cooking skill information for the target user.

12. The information processing method according to claim 7, further comprising:
(H) acquiring a cooking result of a cooking operation that is included in the cooking menu and completed by the target user; and
(I) modifying the accomplishment rate stored in the attribute database on the basis of the cooking result, wherein
in (D), the modified accomplishment rate is acquired as the accomplishment difficulty.

13. An information processing apparatus comprising:
an acquisition part for acquiring a cooking menu indicative of a cooking way of a foodstuff; an extraction part for extracting foodstuff information indicative of the foodstuff to be used for the cooking menu and foodstuff cooking information indicative of the cooking way of the foodstuff on the basis of the cooking menu; and
a determination part for determining an accomplishment difficulty of the cooking menu on the basis of the foodstuff information and the foodstuff cooking information, wherein
the determination part determines the accomplishment difficulty by use of foodstuff property information indicative of two or more properties which are related to cooking of the foodstuff and itemized in both the foodstuff information and the foodstuff cooking information.

14. The information processing apparatus according to claim 13, wherein
the cooking menu includes a plurality of cooking steps, and
the determination part determines an accomplishment difficulty of each of the cooking steps.

15. The information processing apparatus according to claim 13, wherein
the determination part acquires a first value associated with the foodstuff property information on the basis of the foodstuff information,
acquires a second value associated with the foodstuff property information on the basis of the foodstuff cooking information, and
determines the accomplishment difficulty of the cooking menu by combining the first value and the second value with each other.

16. The information processing apparatus according to claim 14, wherein
the acquisition part acquires cooking skill information for a target user; and
the determination part determines whether each of the cooking steps is accomplishable by the target user on the basis of the cooking skill information and the accomplishment difficulty of each of the cooking steps.

17. The information processing apparatus according to claim 16, further comprising:
a generation part for generating, in a case where there is an accomplishable cooking step that is determined to be a cooking step accomplishable by the target user, a display image having accomplishable cooking information indicative of the accomplishable cooking step superimposed on a field indicative of the accomplishable cooking step; and
an output part for outputting the display image.

18. A non-transitory computer readable recording medium storing an information processing program causing a computer to execute a process of:
(A) acquiring a cooking menu indicative of a cooking way of a foodstuff;
(B) extracting foodstuff information indicative of the foodstuff to be used for the cooking menu and foodstuff cooking information indicative of the cooking way of the foodstuff on the basis of the cooking menu; and
(C) determining an accomplishment difficulty of the cooking menu on the basis of the foodstuff information and the foodstuff cooking information, wherein
the accomplishment difficulty is determined by use of foodstuff property information indicative of two or more properties which are related to cooking of the foodstuff and itemized in both the foodstuff information and the foodstuff cooking information.
